(19) United States
(12) Patent Application Publication
(10) Pub. No.: US 2020/0326317 A1
(43) Pub. Date: Oct. 15, 2020

(54) FLUIDIC EJECTION SYSTEMS WITH TITRATION PLATE FORM FACTORS

(71) Applicant: HEWLETT-PACKARD DEVELOPMENT COMPANY, L.P., Spring, TX (US)

(72) Inventors: Christie Dudenhoefer, Corvallis, OR (US); Jeffrey A. Nielsen, Corvallis, OR (US); Debora J. Thomas, Corvallis, OR (US)

(73) Assignee: HEWLETT-PACKARD DEVELOPMENT COMPANY, L.P., Spring, TX (US)

(21) Appl. No.: 16/767,258

(22) PCT Filed: Jan. 30, 2018
(86) PCT No.: PCT/US2018/015838

§ 371 Date: May 27, 2020

(51) Int. Cl. G01N 31/16; B01J 4/02; G01N 35/10

(52) U.S. Cl. CPC G01N 31/16; G01N 35/1074; B01J 4/02

(57) ABSTRACT

In one example in accordance with the present disclosure, a fluidic ejection system is described. The fluidic ejection system includes a frame to retain a number of fluidic ejection devices. The frame has a form factor to match a titration plate. The fluidic ejection system also includes the number of fluidic ejection devices disposed on the frame. Each fluidic ejection device includes a reservoir disposed on a first side of the frame and a fluidic ejection die disposed on an opposite side of the frame. Each fluidic ejection die includes an array of nozzles, with each nozzle including an ejection chamber, an opening, and a fluid actuator disposed within the ejection chamber.

### BACKGROUND

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluidic ejection system with a titration plate form factor, according to an example of the principles described herein.

FIG. 2 is a top view of a fluidic ejection system with a titration plate form factor, according to an example of the principles described herein.

FIG. 3 is a bottom view of a fluidic ejection system with a titration plate form factor, according to an example of the principles described herein.

FIG. 4 is an isometric view of a fluidic ejection system with a titration plate form factor and a titration plate, according to an example of the principles described herein.

FIGS. 5-7 are views of different arrangements of fluidic ejection devices on a frame, according to an example of the principles described herein.

FIG. 8 is a flow chart of a method for making a fluidic ejection system with a titration plate form factor, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

Such assays have been performed manually. That is, a user fills fluid into a single channel pipette, or a multi-channel pipette, and manually disperses a prescribed amount of fluid from the pipette into various wells of a titration plate. As this process is done by hand, it is tedious, complex, and inefficient. Moreover, it is prone to error as a user may misalign the pipette with the wells of the titration plate and/or may dispense an incorrect amount of fluid. Still further, such manual deposition of fluid may be incapable of dispensing low volumes of fluid, for example in the picoliter range.

Accordingly, the present specification describes a fluidic ejection system that increases a throughput for low volume dispensing applications and allows dispensing of fluids into multiple wells of a titration plate. Still further, the present system can be handled by existing automation devices. That is, laboratory equipment may be designed to manipulate titration plates. The fluidic ejection system of the current system is designed such that it can be handled by such equipment. Specifically, the fluidic ejection system includes multiple fluidic ejection devices arranged in an array, and such fluidic ejection devices use a fluid actuator to eject a small amount of fluid into multiple wells of a titration plate. Such a system can operate to eject low volumes of fluid, for example in the picoliter range, into one or multiple wells at a time.

The fluidic ejection devices may be integrated into a frame that has a form factor consistent with a titration plate. That is, the frame may have a same length and width of a titration plate such that it can be handled by the same automated equipment as is used to manipulate the titration plates, without modifying such automated equipment.

Specifically, the present specification describes a fluidic ejection system. The fluidic ejection system includes a frame to retain a number of fluidic ejection devices. The frame has a form factor to match a titration plate. The fluidic ejection system also includes the number of fluidic ejection devices disposed on the frame. Each fluidic ejection device includes a reservoir disposed on a first side of the frame and a fluidic ejection die disposed on an opposite side of the frame. Each fluidic ejection die includes an array of nozzles. Each nozzle includes an ejection chamber, an opening, and a fluid actuator disposed within the ejection chamber.

The present specification also describes a method of making a fluidic ejection system. In the method, a number of reservoirs are formed into a first surface of a frame. The frame has a form factor to match a titration plate. A number of fluidic ejection dies are disposed on a second, and opposite surface of the frame. Each reservoir is fluidly coupled to a corresponding fluidic ejection die and electrical circuitry is formed on the substrate to pass control signals from a controller to the fluidic ejection dies.

In another example, the fluidic ejection system includes the frame and a number of integrated fluidic ejection devices formed in the frame, each fluidic ejection device including an open reservoir and fluidic ejection die. In this example, each of the fluidic ejection devices are individually addressable and are aligned with the wells on the titration plate.

In summary, using such a fluidic ejection system 1) aligns fluidic ejection dies to locations on the substrate such as a titration plate; 2) dispenses from multiple fluidic ejection dies simultaneously to increase the throughput of dispensing; 3) permits for robotic handling by existing liquid handlers, plate stackers, etc. as the frame has a form factor consistent with a standards-controlled titration plate; and 4) aligns the reservoirs with multi-channel pipettes to facilitate easy and quick filling of the fluidic ejection devices.

As used in the present specification and in the appended claims, the term “form factor” refers to the shape of the frame. For example, the form factor may indicate the length and width of the frame.

Further, as used in the present specification and in the appended claims, the term “standards-controlled” refers to a component that is regulated by national and/or international standards. For example, a standards-controlled titration plate may have certain dimensions and well spacings that are regulated by a national and/or international standard. Accordingly, a frame that has a form factor consistent with such national and/or international standards may have at least some similar dimensions and/or spacings.

Still further, as used in the present specification and in the appended claims, the term “a number of” or similar language is meant to be understood broadly as any positive number including 1 to infinity.

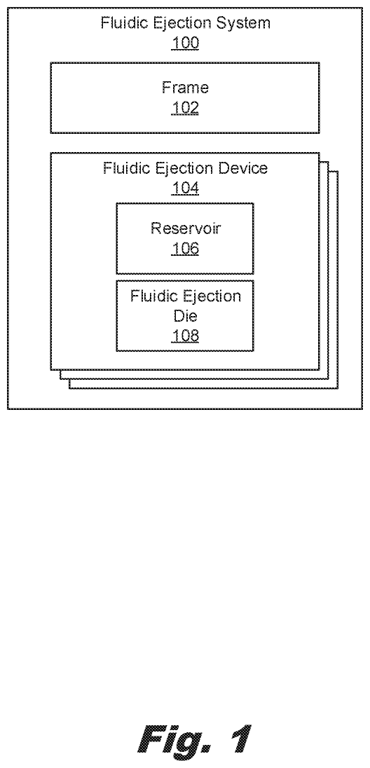

Turning now to the figures, FIG. 1 is a block diagram of a fluidic ejection system (100) with a titration plate form factor, according to an example of the principles described herein. In general, the fluidic ejection system (100) ejects fluid onto a surface. As described above, the surface may be a titration plate with a number of wells, and the fluid may be deposited into the individual wells of the titration plate. A variety of fluids may be deposited. For example, the fluidic ejection system (100) may be implemented in a laboratory and may eject biological fluid. In some examples, the biological fluid may include solvent or aqueous-based pharmaceutical compounds, as well as aqueous-based biomolecules including proteins, enzymes, lipids, antibiotics, mastermix, primer, DNA samples, cells, or blood components, all with or without additives, such as surfactants or glycerol. To eject the fluid, a fluidic ejection controller passes control signals and routes them to fluidic ejection devices (104) of the fluidic ejection system (100).

While specific reference is made to deposition of fluid into wells of a titration plate, the present systems and devices can be used to deposit fluid on other substrates or surfaces such as microscope slides, matrix assisted laser desorption/ionization (MALDI) plates, and microfluidic chips among other substrates or surfaces.

The fluidic ejection system (100) includes a number of fluidic ejection devices (104). A fluidic ejection device (104) is a device that operates to eject fluid onto a surface, such as a well of a titration plate. In some cases, the fluidic ejection devices (104) operate to dispense picoliter quantities of a target fluid into the wells.

Each fluidic ejection device (104) includes a reservoir (106) disposed on a first side of a frame (102). The reservoir (106) holds the fluid to be ejected. In some examples, the reservoir (106) is open, or exposed, so that a user, either manually or via a machine-operated multi-channel pipette, can fill the reservoirs (106) with the target fluid.

Each fluidic ejection device (104) also includes a fluidic ejection die (108). The fluidic ejection die (108) is fluidly coupled to the reservoir (106). That is, during operation, fluid from the reservoir (106) is passed to a fluidic ejection die (108) where it is ejected onto a surface. The fluidic ejection die (108) includes a number of components to eject fluid. In some examples, the fluidic ejection dies (108) and fluidic ejection devices (104) rely on inkjet technology to eject fluid therefrom. Such a fluidic ejection system (100), by using inkjet components such as ejection chambers, openings, and actuators disposed within the micro-fluidic ejection chambers, enables low-volume dispensing of fluids such as those used in life science and clinical applications. Examples of such applications include compound secondary screening, enzyme profiling, dose-response titrations, polymerase chain reaction (FOR) miniaturization, microarray printing, drug-drug combination testing, drug repurposing, drug metabolism and pharmacokinetics (DMPK) dispensing and a wide variety of other life science dispensing.

The fluidic ejection system (100) also includes a frame (102). The fluidic ejection devices (104) may be disposed on the frame (102). In some examples, the fluidic ejection devices (104), or at least the reservoirs (106) of the fluidic ejection devices (104), are integrated into the frame (102). That is, the frame (102) may be injection molded or otherwise formed of a thermoplastic material. In this example, depressions may be formed which correspond to the reservoirs (106) that hold the fluid to be ejected.

The frame (102) may have the same form factor as a titration plate, which titration plate may be standards-controlled. For example, the American National Standards Institute (ANSI) in conjunction with the Society for Biomolecular Sciences (SBS) promulgate certain standards that indicate a spacing of wells in a titration plate as well as a dimension of the titration plate. Accordingly, a frame (102) that has a form factor consistent with such a standards-controlled titration plate may have some similar dimensions. Specifically, the frame (102) may have a same length and width as the standards-controlled titration plate. The reservoirs (106) and fluidic ejection dies (108) may also be spaced similarly as the well-spacing of the titration plate, which spacing may also be standards-controlled, for example by an ANSI/SBS standard.

Accordingly, the fluidic ejection system (100) with a frame (102) that has the same form factor as a titration plate, and more specifically a standards-controlled titration plate, will be able to be moved and stacked with automation equipment developed for moving and stacking titration plates. Inside the external form factor, the multiple fluidic ejection devices (104) can be arrayed as desired to match the well locations for various titration plate types. The reservoirs (106) are also matched with multi-channel pipette tip spacing. While specific reference is made to fluidic ejection device (104) spacing that matches well spacing in a titration plate, the fluid ejection devices (104) may be arrayed within the frame (102) form factor to line up with non-standard location/spacing if desired, for example to match another type of substrate.

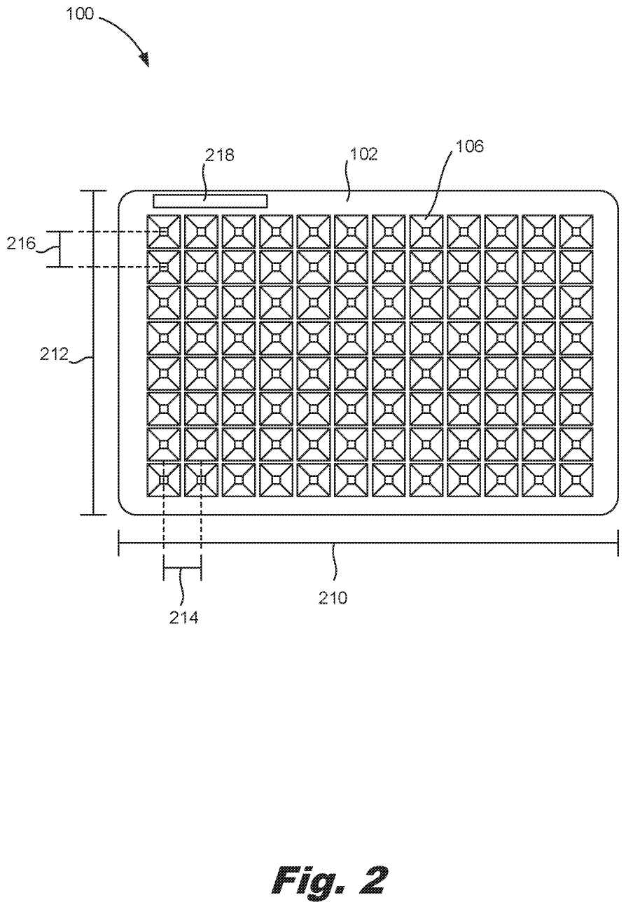

FIG. 2 is a top view of a fluidic ejection system (100) with a titration plate form factor, according to an example of the principles described herein. As described above, the frame (102) may have some similar dimensions as a titration plate. For example, the frame (102) may have a length (210) and width (212) that match those of a titration plate such as a standards-controlled, specifically ANSI/SBS standards-controlled, titration plate. In this example, the frame (102) may have a length (210) of 5.03 inches and a width (212) of 3.36 inches.

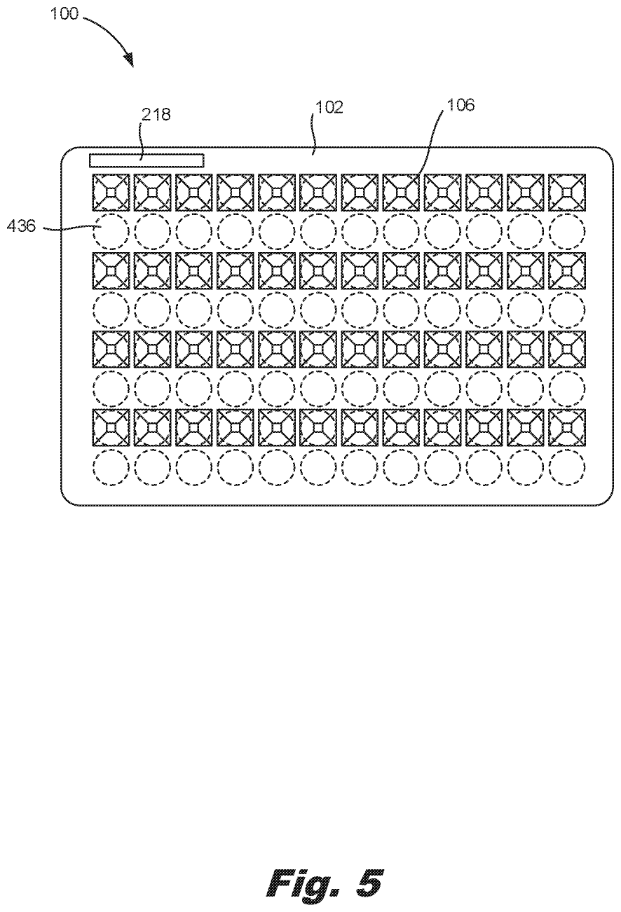

The top of the fluidic ejection system (100) includes reservoirs (106), which may be exposed such that fluid can be dispensed therein without having to remove a cap. For simplicity, one reservoir (106) is indicated with a reference number. In some examples, the number of reservoirs (106) align with the number of wells in a titration plate. For example, as depicted in FIG. 2, the fluidic ejection system (100) includes 96 reservoirs (106) to align with 96 wells in a 96-well titration plate. While specific reference is made to a 96-well titration plate, and thereby a fluidic ejection system (100) with 96 reservoirs (106), other numbers of reservoirs (106) may be used to align with different types of titration plates such as 48, 384, and 1536 well titration plates. Moreover, while FIG. 2 depicts a reservoir (106) per well, in some examples, there may be fewer reservoirs (106) than wells in a titration plate as indicated in FIGS. 5-7 below.

In addition to having the same length (210) and width (212) as a standards-controlled titration plate, other dimensions of the fluidic ejection system (100) may be consistent with the standards-controlled titration plate. One such dimension is a column spacing (214) and row spacing (216) of the reservoirs (106). For example, to align with the wells of a 96-well titration plate, the reservoirs (106) may have a column spacing (214) and row spacing (216) of 0.35 inches measured from centerlines of the reservoirs (106). By comparison, to align with the wells of a 384-well titration plate, the reservoirs (106) may have a column spacing (214) and row spacing (216) of 0.18 inches measured from centerlines of the reservoirs (106). Still further, to align with the wells of a 1536-well titration plate, the reservoirs (106) may have a column spacing (214) and row spacing (216) of 0.09 inches measured from centerlines of the reservoirs (106).

Note that in some examples, the column spacing (214) and row spacing (216) of the reservoirs (106) may be a scaled version of these values, for example in the case when the number of reservoirs (106) is fewer than the number of wells in the titration plate. Doing so ensures that each reservoir (106) aligns with a well, while not all wells receive fluid from a reservoir (106).

In this fashion, each reservoir (106) in a fluidic ejection system (100) is aligned with individual wells in a titration plate. This same inter-reservoir (106) spacing matches a spacing between individual pipettes of a multi-channel pipette such that multiple reservoirs (106) can be filled at the same time, Doing so enables automated, multi-plex filling of fluid into the reservoirs (106), for example, by an 8-channel, 12-channel, 16-channel, 96-channel, or 384-channel pipette. Moreover, by being arrayed into a single SBS-ANSI standard format frame (102), the fluidic ejection system (100) can be operated on by stackers and movers that move titration plates.

In some examples, the frame (102) also houses circuitry to activate each of the fluid actuators. That is, each of the fluid actuators may be individually addressable and may activate based on control signals from a controller. In some examples, rather than have multiple electrical connections, the fluidic ejection system (100) includes a single electrical connection (218) to interface with a controller.

During operation, a fluidic ejection controller passes control signals to the fluidic ejection system (100) via this electrical connection (218). Any number of control signals may be passed. For example, ejection signals may activate actuators on the fluidic ejection devices (104) to eject fluid therefrom. Other types of signals include sensing signals to activate a sensor to collect data regarding the fluidic ejection device or a fluid passing through the fluidic ejection device. As yet another example, a signal may activate a component of the fluidic ejection device (104) to electrically discharge fluid being ejected into the wells of the titration plate. While specific reference is made to particular control signals generated and/or passed, any number and type of control signals may be passed to the fluidic ejection system (100) by the fluidic ejection controller.

An electrical connection is disposed on the fluidic ejection controller. This electrical connection interfaces with the electrical connection (218) on the fluidic ejection system (100) when such a fluidic ejection system is installed. Via this electrical connection, signals are passed that activate the fluidic ejection devices (104) to eject fluid therethrough.

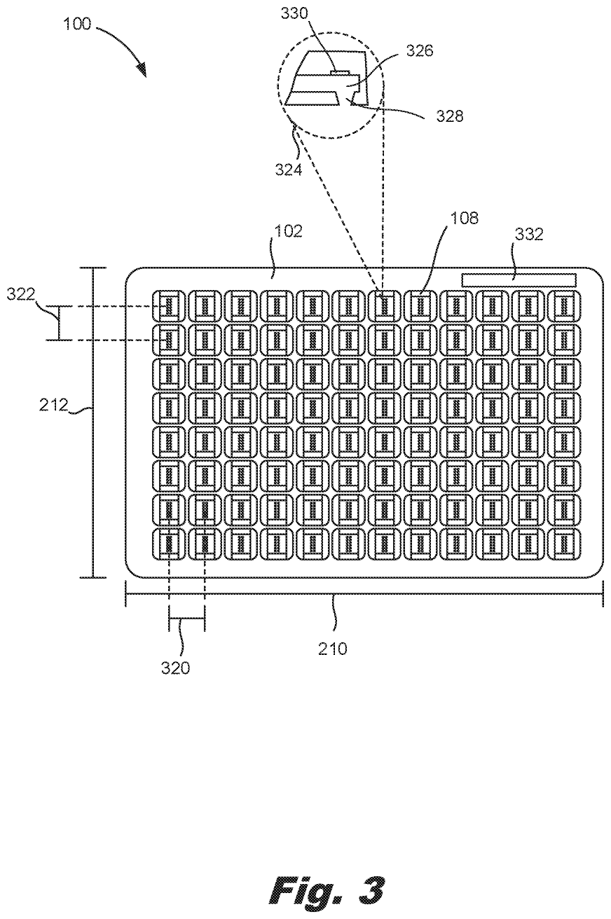

FIG. 3 is a bottom view of a fluidic ejection system (100) with a titration plate form factor, according to an example of the principles described herein. As described above; the frame (102) may have a length (210) and width (212) that match those of a titration plate such as a standards-controlled, specifically ANSI/SBS standards-controlled, titration plate.

The bottom of the fluidic ejection system (100) includes fluidic ejection dies (108). In one example; each fluidic ejection die (108), and therefore each fluidic ejection device (FIG. 1, 104), is a separate structure. For simplicity, one fluidic ejection die (108) is indicated with a reference number. The fluidic ejection dies (108) are fluidly connected to the reservoirs (FIG. 1, 106) via a number of slots, channels, and chambers. That is, fluid is fed, via gravity from the reservoir (FIG. 1, 106) along a flow path to a fluidic ejection die (108).

Each fluidic ejection die (108) includes an array of nozzles (324). Each nozzle (324) includes a number of components. For example, a nozzle (324) includes an ejection chamber (326) to hold an amount of fluid to be ejected, an opening (328) through which the amount of fluid is ejected, and an actuator (330), disposed within the ejection chamber (326), to eject the amount of fluid through the opening (328). It should be noted that the relative size of the nozzle openings (328) and the fluidic ejection die (108) are not to scale, with the nozzles (324) being enlarged for purposes of illustration.

Turning to the actuators (330), the actuator (330) may include a firing resistor or other thermal device, a piezoelectric element, or other mechanism for ejecting fluid from the ejection chamber (326). For example, the actuator (330) may be a firing resistor. The firing resistor heats up in response to an applied voltage. As the firing resistor heats up, a portion of the fluid in the ejection chamber (326) vaporizes to form a bubble. This bubble pushes fluid out the opening (328) and onto the print medium. As the vaporized fluid bubble collapses, fluid is drawn into the ejection chamber (326) from a passage that connects nozzle (324) to a fluid feed slot in the fluidic ejection die (108), and the process repeats. In this example, the fluidic ejection die (108) may be a thermal inkjet (TIJ) fluidic ejection die (108).

In another example, the actuator (330) may be a piezoelectric device. As a voltage is applied, the piezoelectric device changes shape which generates a pressure pulse in the ejection chamber (326) that pushes the fluid out the opening (328) and onto the print medium. In this example, the fluidic ejection die (108) may be a piezoelectric inkjet (PIJ) fluidic ejection die (108). In addition to these components, the fluidic ejection die (108) may include a number of fluidic channels and chambers through which the fluid placed in the reservoir (FIG. 1, 106) may flow through and out of the nozzles (324).

In some examples, the number of fluidic ejection dies (108) align with the number of wells in a titration plate. For example, as depicted in FIG. 3, the fluidic ejection system (100) includes 96 fluidic ejection dies (108) to align with 96 wells in a 96-well titration plate. While specific reference is made to a 96-well titration plate, and thereby a fluidic ejection system (100) with 96 fluidic ejection dies (108), other numbers of fluidic ejection dies (108) may be used to align with different types of titration plates such as 48, 384, and 1536 well titration plates. Moreover, while FIG. 3 depicts a fluidic ejection dies (108) per well, in some examples, there may be fewer fluidic ejection dies (108) than wells in a titration plate as indicated in FIGS. 5-7 below.

In addition to having the same length (210) and width (212) as a standards-controlled titration plate, other dimensions of the fluidic ejection system (100) may be consistent with the standards-controlled titration plate. One such dimension is a column spacing (320) and row spacing (322) of the fluidic ejection dies (108). For example, to align with the wells of a 96-well titration plate, the fluidic ejection dies (108) may have a column spacing (320) and row spacing (322) of 0.35 inches measured from centerlines of the fluidic ejection dies (108). By comparison, to align with the wells of a 384-well titration plate, the fluidic ejection dies (108) may have a column spacing (320) and row spacing (322) of 0.18 inches measured from centerlines of the fluidic ejection dies (108). Still further, to align with the wells of a 1536-well titration plate, the fluidic ejection dies (108) may have a column spacing (320) and row spacing (322) of 0.09 inches measured from centerlines of the fluidic ejection dies (108).

Note that in some examples, the column spacing (320) and row spacing (322) of the fluidic ejection dies (108) may be a factorial of these values, for example in the case when the number of fluidic ejection dies (108) is fewer than the number of wells in the titration plate. Doing so ensures that each fluidic ejection die (108) aligns with a well, while not all wells receive fluid from a fluidic ejection die (108). In this fashion, each fluidic ejection die (108) in a fluidic ejection system (100) is aligned with individual wells in a titration plate.

As noted in the examples depicted in FIGS. 2 and 3, the fluidic ejection system (100) may include any number of reservoirs (106) and any number of fluidic ejection dies (108) which may or may not match and may or may not be the same as the number of wells in a titration plate. However, the fluidic ejection dies (108), and more specifically the array of nozzles (324), are aligned with wells in the titration plates. In some examples, the reservoirs (FIG. 1, 106) may also be aligned with the wells.

In some examples, the bottom surface of the frame (102) also houses circuitry to activate each of the fluid actuators. That is, each of the fluid actuators (330) may be individually addressable and may activate based on control signals from a controller. In some examples, rather than having multiple electrical connections, the fluidic ejection system (100) includes a single electrical connection (332) to receive signals from the fluidic ejection controller. In this fashion, fluidic ejection dies (108) can be fired individually, in groups, or all together depending on the application and throughput considerations.

By aligning fluidic ejection dies (108) with wells in titration plates, and in particular with standards-controlled titration plates, exact fluidic ejection is promoted, and multi-plex dispensing from the fluidic ejection dies (108) is enabled.

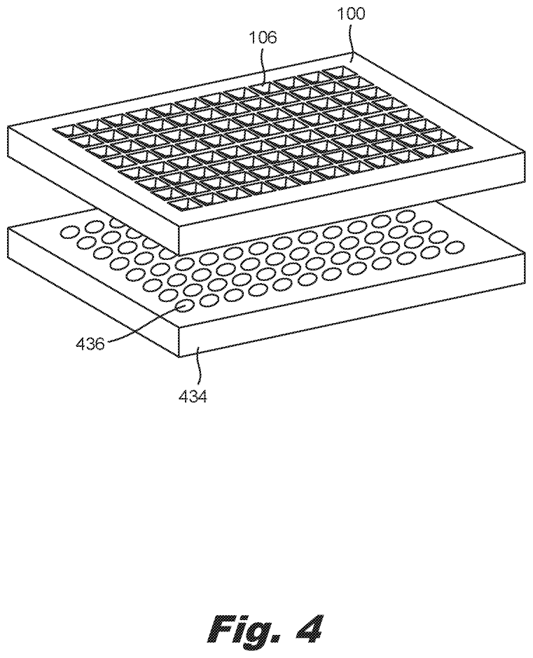

FIG. 4 is an isometric view of a fluidic ejection system (100) with a titration plate form factor and a titration plate (434), according to an example of the principles described herein. The titration plate (434) may be any plate that receives a fluid ejected from the fluidic ejection system (100). The titration plate (434) includes a number of wells (436) into which the fluid may be ejected. For simplicity, a single well (436) and single reservoir (106) are indicated with reference numbers. In some examples, the titration plate (434) may further include a structure to which a handling system may interact with to move the titration plate (434).

During fluidic ejection, the fluidic ejection system (100) is disposed above the titration plate (434) such that fluid expelled from the fluidic ejection system (100) is deposited in individual wells (436) of the titration plate. As has been mentioned, while FIG. 4 depicts a 96 well titration plate (434), the titration plate (434) may include any number of wells (436). As can be clearly seen in FIG. 4, the shared length and width of the titration plate (434) and fluidic ejection system (100) allow for the fluidic ejection system (100) to be handled by the same equipment used to handle the titration plate (434). As described above, while specific reference is made to deposition of a fluid into a titration plate (434), the fluidic ejection system (100) may deposit fluid onto other surfaces or substrates.

FIGS. 5-7 are views of different arrangements of fluidic ejection devices (FIG. 1, 104) on the frame (102), according to an example of the principles described herein. As described above, in some examples, the number of fluidic ejection devices (FIG. 1, 104) and their corresponding reservoirs (106) and fluidic ejection dies (FIG. 1, 108) may be less than the number of wells (436). In these examples, a number of different arrangements may be possible.

For example, as depicted in FIG. 5, there may be 48 fluidic ejection devices (FIG. 1, 104) arrayed along a fluidic ejection system (100) having a spacing that corresponds to the well-spacing of a 96-well titration plate (FIG. 4, 434). In this example, each fluidic ejection device (FIG. 1, 104) may correspond to a well (436), but not all wells (436) receive fluid. In FIGS. 5-7, the wells (436) are depicted in dashed lines to indicate their position underneath the fluidic ejection system (100). In the example depicted in FIG. 5, the fluidic ejection devices (FIG. 1, 104) are aligned with alternating rows.

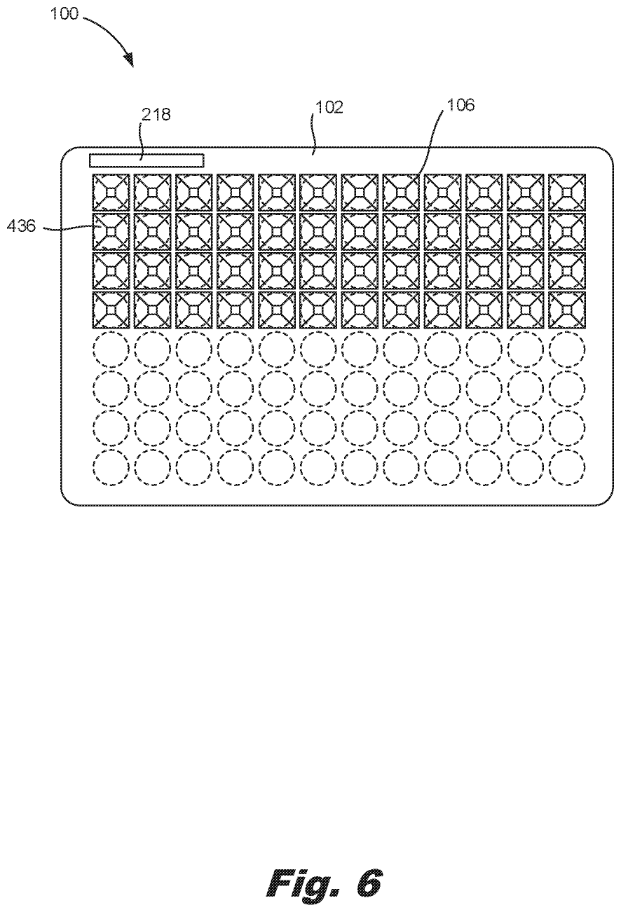

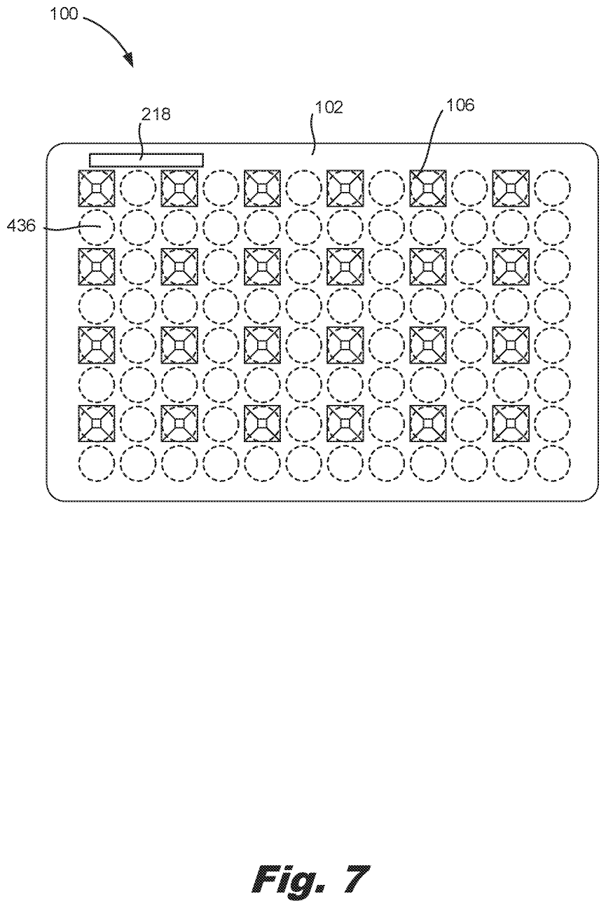

In the example depicted in FIG. 6, the fluidic ejection devices (FIG. 1, 104), and their corresponding reservoirs (106) are clustered to align with wells (436) in a top half of the titration plate (FIG. 4, 434). FIG. 7 shows yet another example, where the fluidic ejection devices (FIG. 1, 104) and their corresponding reservoirs (106) are arrayed in yet another arrangement. As depicted in these figures, while the external form factor of the frame (102) adheres to standards-controlled titration plates (FIG. 4, 434) for ease of automation robot handing, the number and alignment of the individually addressable fluidic ejection devices (FIG. 1, 104) can vary. While FIGS. 5-7 depict specific arrangements of fluidic ejection devices (FIG. 1, 104) in the system, other arrangements are available as well.

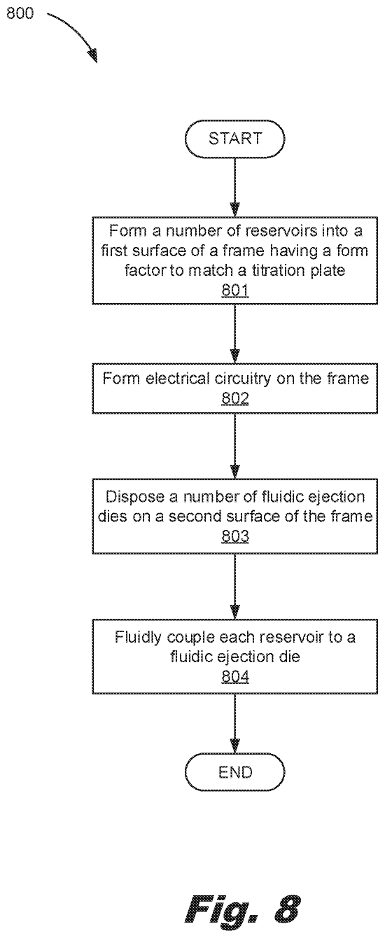

FIG. 8 is a flow chart of a method (800) for forming a fluidic ejection system (100) with a titration plate form factor, according to an example of the principles described herein, According to the method (800), a number of reservoirs (FIG. 1, 106) are formed (block 801) into a first surface of a frame (FIG. 1, 102). For example, the frame (FIG. 1, 102) may be formed from a thermoplastic material such as an epoxy mold compound material. In this example, protrusions in a mold may be formed such that when the material is deposited in a mold, depressions are formed, which depressions serve as the reservoirs (FIG. 1, 106). In other examples, the reservoirs (FIG. 1, 106) may be machined into a surface of the frame (FIG. 1, 102). As described above, the number and arrangement of the fluidic ejection devices (FIG. 1, 104) in the frame (FIG. 1, 102) may be selected based on the application or other criteria.

The frame (FIG. 1, 102) may be sized to have a form factor consistent with a titration plate (FIG. 4, 434), That is, a material may be placed in a mold with a length and width that match the length and width of a titration plate (FIG. 4, 434). In another example, the frame (FIG. 1, 102) may be cut to the desired dimensions.

Electrical circuitry is formed (block 802) on the frame (FIG. 1, 102) such that electrical control signals, such as ejection signals, can be passed from a fluidic ejection controller to the fluidic ejection system (FIG. 1, 100).

A number of fluidic ejection dies (FIG. 1, 108) are disposed (block 803) on a second surface of the frame (FIG. 1, 102). For example, the fluidic ejection dies (FIG. 1, 108) could be adhered via an adhesive to the second side of the frame (FIG. 1, 102). The forming (block 801) of the reservoirs (FIG. 1, 106) and disposing (block 803) of the fluidic ejection dies (FIG. 108) may be done such that a spacing between adjacent reservoirs (FIG. 1, 106) and between adjacent fluidic ejection dies (FIG. 1, 108) match a spacing of wells (FIG. 4, 436) on a titration plate (FIG. 4, 434) or integer scalers thereof.

Each reservoir (FIG. 1, 106) is fluidically coupled (block 804) to a corresponding fluidic ejection die (FIG. 1, 108). This can be done by forming a slot, either during molding or subsequently, between the reservoir (FIG. 1, 106) on the first surface of the frame (FIG. 1, 102) towards the second surface of the frame (FIG. 1, 102). The fluidic ejection die (FIG. 1, 108) can then be aligned with the slot.

In summary, using such a fluidic ejection system 1) aligns fluidic ejection dies to locations on the substrate such as a titration plate; 2) dispenses from multiple fluidic ejection dies simultaneously to increase the throughput of dispensing; 3) permits for robotic handling by existing liquid handlers, plate stackers, etc. as the frame has a form factor consistent with a standards-controlled titration plate; and 4) aligns the reservoirs with multi-channel pipettes to facilitate easy and quick filling of the fluidic ejection devices.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluidic ejection system, comprising:
a frame to retain a number of fluidic ejection devices, wherein the frame has a form factor to match a titration plate; and
the number of fluidic ejection devices disposed on the frame; wherein each fluidic ejection device comprises:
a reservoir disposed on a first side of the frame; and
a fluidic ejection die disposed on an opposite side of the frame; wherein each fluidic ejection die comprises an array of nozzles, each nozzle comprising:
an ejection chamber;
an opening; and
a fluid actuator disposed within the ejection chamber.

2. The system of claim 1, wherein the titration plate is a standards-controlled titration plate.

3. The system of claim 1; wherein the fluid is a biological fluid.

4. The system of claim 1, wherein the fluidic ejection die of each fluidic ejection device aligns with a well on the titration plate.

5. The system of claim 1, wherein the number of fluidic ejection dies matches the number of wells in the titration plate.

6. The system of claim 1; wherein the reservoirs of the fluidic ejection devices are exposed.

7. The system of claim 1, further comprising circuitry to activate each of the fluid actuators and wherein each of the fluid actuators is individually addressable.

8. A fluidic ejection system, comprising:
a frame to retain a number of fluidic ejection devices, wherein the frame has a form factor to match a titration plate; and
the number of fluidic ejection devices integrally formed in the frame, wherein each fluidic ejection device comprises:
an open reservoir disposed on a first side of the frame; and
a fluidic ejection die disposed on an opposite side of the frame, wherein each fluidic ejection die comprises an array of nozzles, each nozzle comprising:
an ejection chamber;
an opening; and
a fluid actuator disposed within the ejection chamber,
wherein each of the fluidic ejection devices are individually addressable; and
the number of fluidic ejection devices are aligned with wells on the titration plate.

9. The system of claim 8, wherein the titration plate is a standards-controlled titration plate.

10. The system of claim 8, wherein a spacing between adjacent reservoirs matches:
a spacing between individual pipettes of a multi-channel pipette; and
a spacing between individual wells of the titration plate.

11. The system of claim 8, wherein the number of fluidic ejection dies is less than the number of wells in the titration plate.

12. A method of forming a fluidic ejection system comprising:
forming a number of reservoirs into a first surface of a frame, the frame having a form factor to match a titration plate;
disposing a number of fluidic ejection dies on a second, and opposite, surface of the frame;
fluidly coupling each reservoir to a corresponding fluidic ejection die; and
forming electrical circuitry to pass control signals from a controller to the number of fluidic ejection dies.

13. The method of claim 12, wherein disposing the number of fluidic ejection dies on the second surface comprises disposing the number of fluidic ejection dies such that the number of fluidic ejection dies have an inter-die spacing that matches an inter-well spacing of wells on a standards-controlled titration plate.

14. The method of claim 12, wherein each fluidic ejection die ejects fluid on a picoliter scale.

15. The method of claim 12, wherein the frame is 5.03 inches by 3.36 inches.
